(19) United States
(12) Patent Application Publication
(10) Pub. No.: US 2025/0196895 A1
(43) Pub. Date: Jun. 19, 2025

(54) APPARATUS FOR CONTROLLING A VEHICLE AND A METHOD THEREOF

(71) Applicants: HYUNDAI MOTOR COMPANY, Seoul (KR); KIA CORPORATION, Seoul (KR)

(72) Inventor: Dae Young Kim, Gwangmyeong-si (KR)

(73) Assignees: HYUNDAI MOTOR COMPANY, Seoul (KR); KIA CORPORATION, Seoul (KR)

(21) Appl. No.: 18/757,100

(22) Filed: Jun. 27, 2024

(30) Foreign Application Priority Data
Dec. 13, 2023 (KR) 10-2023-0181226

(51) Int. Cl. B60W 60/00; B60W 50/00

(52) U.S. Cl. CPC B60W 60/0053; B60W 50/0098; B60W 60/0057; B60W 2050/0022

(57) ABSTRACT

A vehicle control device includes a processor and a steering wheel that specifies a driving direction of a host vehicle. The processor may determine that the host vehicle is under autonomous driving control. The processor may determine a threshold value or a threshold time value based on at least one of a maximum deceleration value among decelerations of the host vehicle measured during a specified time, a grip strength with which the steering wheel is gripped, or any combination thereof. The processor may switch control of driving of the host vehicle from a system for performing the autonomous driving to a driver based on the steering wheel being operated with an amount of operation greater than the threshold value or for a time greater than the threshold time value.

### CROSS-REFERENCE TO RELATED APPLICATION

This application claims the benefit of priority to Korean Patent Application No. 10-2023-0181226, filed in the Korean Intellectual Property Office on Dec. 13, 2023, the entire contents of which are incorporated herein by reference.

### TECHNICAL FIELD

The present disclosure relates to a vehicle control device and a vehicle control method and more specifically, to a technology for controlling a vehicle according to a driver's input in a vehicle under autonomous driving control.

### BACKGROUND

Autonomous driving technology has been developed to improve driving stability and driver convenience.

As technology for adjusting driving routes and avoiding obstacles becomes more sophisticated, the scope and frequency of driver intervention required for driving is decreasing. However, in a specific situation, there is a need to control the vehicle through intervention of a human driver even when autonomous driving is being performed.

Research is being conducted to compare and weigh driving safety improvement and driver convenience improvement to determine whether a driver's judgment or an autonomous driving system's judgment should be given priority.

### SUMMARY

The present disclosure has been made to solve the above-mentioned problems occurring in the prior art while advantages achieved by the prior art are maintained intact.

Aspects of the present disclosure provide a vehicle control device and a vehicle control method that determine whether the operation of a steering wheel is caused by a driver's intention based on the amount of operation of the steering wheel of a host vehicle or by a time for which the operation of the steering wheel is maintained under autonomous driving control.

Aspects of the present disclosure provide a vehicle control device and a vehicle control method that identify whether the operation of the steering wheel is caused by a driver's intention based on the driver's gaze under autonomous driving control.

Aspects of the present disclosure provide a vehicle control device and a vehicle control method that reduce an accident risk due to operation of a steering wheel under autonomous driving control.

The technical problems to be solved by the present disclosure are not limited to the aforementioned problems. Any other technical problems not mentioned herein should be more clearly understood from the following description by those of ordinary skill in the art to which the present disclosure pertains.

According to an aspect of the present disclosure, a vehicle control device includes a processor and a steering wheel that specifies a driving direction of a host vehicle.

According to an embodiment, the processor may determine that the host vehicle is under autonomous driving control. The processor may also determine a threshold value or a threshold time value based on at least one of a maximum deceleration value among decelerations of the host vehicle measured during a specified time, a grip strength with which a steering wheel is gripped, or any combination thereof. The processor may switch control of driving of the host vehicle from a system for performing the autonomous driving to the driver based on the steering wheel being operated with an amount of operation greater than the threshold value or for a time greater than the threshold time value.

According to an embodiment, the processor may determine the threshold value based on a specified threshold value. The processor may also determine the threshold time value based on a specified threshold time value in a failure situation in which the steering wheel is not operated by the autonomous driving control.

According to an embodiment, the processor may determine the threshold value to be a first value based on the maximum deceleration value being a first magnitude. The processor may also determine the threshold value to be a second value greater than the first value based on the maximum deceleration value being the first magnitude.

According to an embodiment, the processor may determine the threshold time value to be a third value based on the maximum deceleration value being a third magnitude. THE processor may also determine the threshold time value to be a fourth value greater than the third value based on the maximum deceleration value being a fourth magnitude greater than the third magnitude.

According to an embodiment, the processor may assign a first weight value as an operation weight based on the grip strength with which the steering wheel is gripped being a first strength. The processor may also assign a second weight value less than the first weight value as the operation weight based on the grip strength with which the steering wheel is gripped being a second strength greater than the first strength. The threshold time value determined based on the first weight value may be greater than a threshold time value determined based on the second weight value.

According to an embodiment, the processor may assign a third weight value as a time weight based on the grip strength with which the steering wheel is gripped being a third strength. The processor may also assign a fourth weight value less than the third weight value as the time weight based on the grip strength with which the steering wheel is gripped being the fourth strength greater than the third strength. The threshold time value determined based on the third weight value may be greater than a threshold time value determined based on the fourth weight value.

According to an embodiment, the processor may assign a fifth weight value as an operation weight, based on the driver not gripping the steering wheel and may assign a sixth weight value less than the fifth weight value as the operation weight based on the driver gripping the steering wheel. The threshold value determined based on the fifth weight value may be greater than a threshold value determined based on the sixth weight value.

According to an embodiment, the processor may assign a seventh weight value as a time weight, based on the driver not gripping the steering wheel and may assign an eighth weight value less than the seventh weight value as the time weight based on the driver gripping the steering wheel. The threshold time value determined based on the seventh weight value may be greater than a threshold time value determined based on the eighth weight value.

According to an embodiment, the processor may identify the grip strength with which the steering wheel is gripped based on at least one of a contact area between the driver and the steering wheel, a distance between the driver and the steering wheel, or any combination thereof.

According to an embodiment, the processor may identify the grip strength with which the steering wheel is gripped through a touch sensor included in the steering wheel or may identify the amount of operation of the steering wheel through a torque sensor included in the steering wheel.

According to an aspect of the present disclosure, a vehicle control method includes determining that the host vehicle is under autonomous driving control. The method also includes determining a threshold value or a threshold time value based on at least one of a maximum deceleration value among decelerations of the host vehicle measured during a specified time, a grip strength with which a steering wheel is gripped, or any combination thereof. The method also includes switching control of driving of the host vehicle from a system for performing the autonomous driving to the driver based on the steering wheel being operated with an amount of operation greater than the threshold value and for a time greater than the threshold time value.

According to an embodiment, the vehicle control method may further include determining the threshold value based on a specified threshold value operation. The method may also include determining the threshold time value based on a specified threshold time value in a failure situation in which the steering wheel is not operated by the autonomous driving control.

According to an embodiment, determining the threshold value or the threshold time value may include determining the threshold value to be a first value based on the maximum deceleration value being a first magnitude and may include identifying the threshold value to be a second value greater than the first value based on the maximum deceleration value being the first magnitude.

According to an embodiment, determining the threshold value or the threshold time value may include determining the threshold time value to be a third value based on the maximum deceleration value being a third magnitude and may include determining the threshold time value to be a fourth value than the third value based on the maximum deceleration value being a fourth magnitude greater than the third magnitude.

According to an embodiment, determining the threshold value or the threshold time value may include assigning a first weight value as a operation weight based on the grip strength with which the steering wheel is gripped being a first strength and may include assigning a second weight less than the first weight as the operation weight based on the grip strength with which the steering wheel is gripped being a second strength greater than the first strength. The threshold time value identified based on the first weight value may be greater than a threshold time value identified based on the second weight value.

According to an embodiment, determining the threshold value or the threshold time value may include assigning a third weight value as a time weight based on the grip strength with which the steering wheel is gripped being a third strength and may include assigning a fourth weight value less than the third weight value as the time weight based on the grip strength with which the steering wheel is gripped being the fourth strength greater than the third strength. The threshold time value determined based on the third weight value may be greater than a threshold time value determined based on the fourth weight value.

According to an embodiment, determining the threshold value or the threshold time value may include assigning a fifth weight value as an operation weight based on the driver not gripping the steering wheel and may include assigning a sixth weight value less than the fifth weight value as the operation weight based on the driver gripping the steering wheel. The threshold value determined based on the fifth weight value may be greater than a threshold value determined based on the sixth weight value.

According to an embodiment, determining the threshold value or the threshold time value may include assigning a seventh weight value as a time weight based on the driver not gripping the steering wheel and may include assigning an eighth weight value less than the seventh weight value as the time weight based on the driver gripping the steering wheel. The threshold time value determined based on the seventh weight value may be greater than a threshold time value determined based on the eighth weight value.

According to an embodiment, determining the threshold value or the threshold time value may include identifying the grip strength with which the steering wheel is gripped based on at least one of a contact area between the driver and the steering wheel, a distance between the driver and the steering wheel, or any combination thereof.

According to an embodiment, determining the threshold value or the threshold time value may include identifying the strength with which the steering wheel is gripped through a touch sensor included in the steering wheel.

According to an embodiment, switching the control of driving of the host vehicle from a system for performing the autonomous driving to the driver based on the steering wheel being operated with an amount of operation greater than the threshold value and for a time greater than the threshold time value may include identifying the amount of operation of the steering wheel through a torque sensor included in the steering wheel.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram showing the configuration of a vehicle control device according to an embodiment of the present disclosure;

FIG. 2 is a block diagram specifically illustrating a configuration of a vehicle control device according to an embodiment of the present disclosure;

FIG. 3 shows an example of a host vehicle decelerating in a vehicle control device or vehicle control method according to an embodiment of the present disclosure;

FIG. 4 shows an example of graphs showing the relationship between decelerations and thresholds in a vehicle control device or vehicle control method according to an embodiment of the present disclosure;

FIG. 5 shows an example of a table showing the relationship between the gripping state of a steering wheel and weights in a vehicle control device or vehicle control method according to an embodiment of the present disclosure;

FIG. 6 shows a flowchart of operation of a vehicle control device for switching control of driving from an autonomous driving system to a driver based on a threshold value according to a deceleration and a threshold time value in a vehicle control device or a vehicle control method according to an embodiment of the present disclosure;

FIG. 7 shows a flowchart of operation of a vehicle control device for switching control of driving form an autonomous driving system to a driver in a vehicle control device or a vehicle control method according to an embodiment of the present disclosure; and

FIG. 8 shows a computing system related to a vehicle control device or vehicle control method according to an embodiment of the present disclosure.

### DETAILED DESCRIPTION

Hereinafter, some embodiments of the present disclosure are described in detail with reference to the accompanying drawings. In adding the reference numerals to the components of each drawing, it should be noted that the identical or equivalent component is designated by the identical numeral even when they are displayed on different drawings. Further, in describing the embodiments of the present disclosure, a detailed description of well-known features or functions has been omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component. Thus, the terms do not limit the nature, sequence, or order of the constituent components. Unless otherwise defined, all terms used herein, including technical or scientific terms, have the same meanings as those generally understood by those of ordinary skill in the art to which the present disclosure pertains. Such terms as those defined in a generally used dictionary are to be interpreted as having meanings consistent with the contextual meanings in the relevant field of art. Such terms are not to be interpreted as having ideal or excessively formal meanings unless clearly defined as having such in the present application.

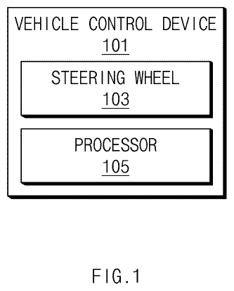

When a controller, module, component, device, element, or the like of the present disclosure is described as having a purpose or performing an operation, function, or the like, the controller, module, component, device, or element should be considered herein as being “configured to” meet that purpose or to perform that operation or function. Each controller, module, component, device, element, and the like may separately embody or be included with a processor and a memory, such as a non-transitory computer readable media, as part of the apparatus. Hereinafter, embodiments of the present disclosure are described in detail with reference to FIGS. 1-8.

FIG. 1 is a block diagram showing the configuration of a vehicle control device according to an embodiment of the present disclosure.

A vehicle control device 101 according to an embodiment of the present disclosure may be implemented inside or outside a vehicle. Some of the components included in the vehicle control device 101 may be implemented inside or outside the vehicle.

Referring to FIG. 1, the vehicle control device 101 may include at least one of a steering wheel 103, a processor 105, or any combination thereof. At least one of the steering wheel 103, the processor 105, or any combination thereof may be electronically and/or operably coupled with each other by an electronic component, such as a communication bus.

According to an embodiment, hereinafter, operatively combining pieces of hardware may mean a direct connection or an indirect connection between the pieces of hardware being established in a wired or wireless manner such that first hardware of the pieces of hardware is controlled by second hardware of the pieces of hardware. The type and/or number of hardware included in the vehicle control device 101 is not limited to that shown in FIG. 1. For example, the vehicle control device 101 may include only some of the hardware components shown in FIG. 1.

According to an embodiment, the steering wheel 103 may be operated by a driver to specify a driving direction of a host vehicle. The processor 105 of the vehicle control device 101 may control the driving status of the host vehicle based on the steering wheel 103. For example, the processor 105 of the vehicle control device 101 may obtain the driver's input to change the driving direction of the host vehicle through the steering wheel 103 and may change the driving direction of the host vehicle based on the driver's input to change the driving direction.

According to an embodiment, the processor 105 of the vehicle control device 101 may identify whether the host vehicle is under autonomous driving control. When a host vehicle having an existing vehicle control device is under autonomous driving, the driving direction of the host vehicle may not be controlled based on the driving direction of the host vehicle determined according to the amount of operation of the steering wheel 103 even though the driver operates the steering wheel 103. This is because, when the host vehicle is under autonomous driving control, an accident risk may be high when the driving direction is changed by operating the steering wheel. Further, this is because, when a host vehicle having an existing vehicle control device is under autonomous driving control, the steering wheel 103 may not be operated according to the user's intention.

According to an embodiment, when the driver operates the steering wheel 103 to improve usability, the processor 105 of the vehicle control device 101 may switch control of driving of the host vehicle from a system for performing autonomous driving to the driver according to the amount of operation of the steering wheel 103. The control of driving of the host vehicle may include control of the driving direction of the host vehicle or control of the driving speed of the host vehicle.

However, when there is an accident risk, the processor 105 of the vehicle control device 101 according to an embodiment may not switch control of driving of the host vehicle to the driver even when the driver operates the steering wheel 103. The situation in which there is an accident risk may include a situation where the operation of the steering wheel 103 is not due to the user's intention or may include a situation where there is a risk of rollover or collision due to a sudden change in direction.

Accordingly, the processor 105 of the vehicle control device 101 may determine whether a condition that the steering wheel is operated with an amount of operation greater than a threshold value and for a time greater than a threshold time value is satisfied, to determine whether an accident risk is less than a reference value. This is because torque may be applied to the steering wheel 103 due to friction between the front wheel and the ground according to the operation of the host vehicle.

Accordingly, the processor 105 of the vehicle control device 101 may determine whether a condition that the steering wheel 103 is operated with the amount of operation greater than the threshold value and for the time greater than the threshold time value is satisfied, to determine whether the torque applied to the steering wheel 103 is caused by operation according to the driver's intention, rather than by friction between the front wheel and the ground.

According to an embodiment, the threshold value and the threshold time value may be determined based on a maximum deceleration value among decelerations of the host vehicle measured during a specified time, a grip strength with which the steering wheel 103 is gripped, or whether there is a failure situation.

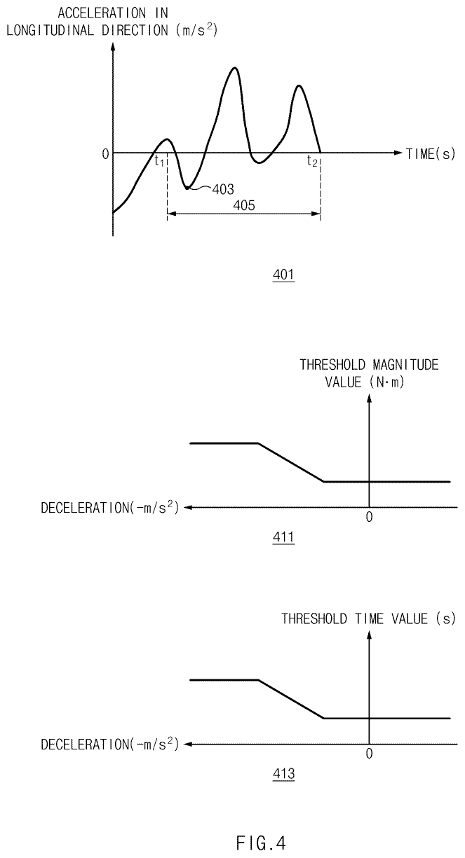

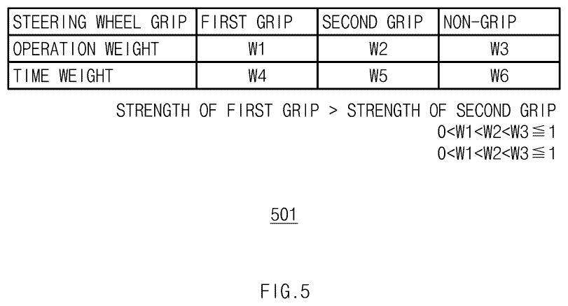

The threshold value and the threshold time value are described in detail below with reference to FIGS. 4 and 5.

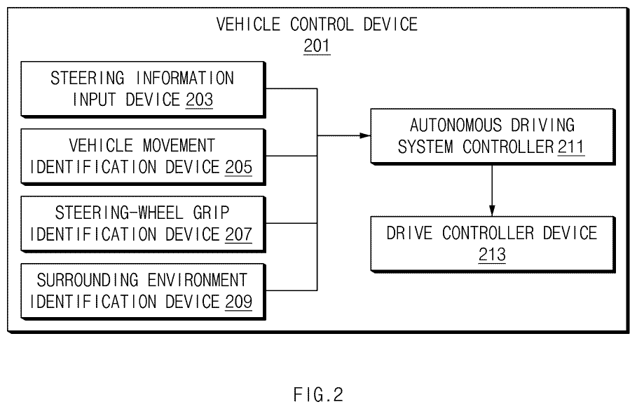

FIG. 2 is a block diagram specifically illustrating a configuration of a vehicle control device according to an embodiment of the present disclosure.

A vehicle control device 201 according to an embodiment of the present disclosure may be implemented inside or outside a vehicle. Some of components included in the vehicle control device 201 may be implemented inside or outside the vehicle.

Referring to FIG. 2, the vehicle control device 201 may include a steering information input device 203, a vehicle movement identification device 205, a steering-wheel grip identification device 207, a surrounding environment identification device 209, an autonomous driving system controller 211, a drive controller 213, or at least one of any combination thereof. The steering information input device 203, the vehicle movement identification device 205, the steering-wheel grip identification device 207, the surrounding environment identification device 209, the autonomous driving system controller 211, the drive controller 213, or the at least one of any combination thereof may be electrically and/or operatively connected to each other by electronic components, such as a communication bus.

The type and/or number of hardware included in the vehicle control device 201 is not limited to that shown in FIG. 2. For example, the vehicle control device 201 may include only some of hardware components shown in FIG. 2.

According to an embodiment, the processor of the vehicle control device 201 may determine whether an accident risk is less than a reference value when the control of driving is switched to the driver based on information determined by the steering information input device 203, the vehicle movement identification device 205, the steering-wheel grip identification device 207, and/or the surrounding environment identification device 209.

According to an embodiment, the vehicle control device 201 may switch control of driving to the driver when an accident risk is less than the reference value even when control of driving is switched from the system for performing autonomous driving to the driver. When the control of driving is switched to the driver, the drive controller 213 may control the driving direction of the host vehicle in a driving direction determined based on the amount of operation of the steering wheel.

According to an embodiment, the steering information input device 203 may identify the amount of operation of the steering wheel. For example, the steering information input device 203 may identify the amount of operation of the steering wheel through a torque sensor included in the steering wheel, but embodiments of the present disclosure may not be limited thereto. The amount of operation of the steering wheel may be identified based on a torque or a force applied to the steering wheel.

According to an embodiment, the vehicle movement identification device 205 may identify the speed, deceleration, and acceleration of the host vehicle.

According to an embodiment, the steering-wheel grip identification device 207 may identify the driver's steering wheel grip state. For example, the steering-wheel grip identification device 207 may identify a grip strength with which the steering wheel is gripped. For example, the steering-wheel grip identification device 207 may determine whether the steering wheel is gripped by one hand, both hands, or not gripped. The steering-wheel grip identification device 207 may identify a grip strength with which the steering wheel is gripped through a touch sensor included in the steering wheel. The touch sensor may include a hydrostatic sensor or a capacitive sensor.

According to an embodiment, the surrounding environment identification device 209 may identify the location or speed of an external object. For example, the surrounding environment identification device 209 can identify the location and speed of a surrounding vehicle.

According to an embodiment, the autonomous driving system controller 211 may determine the driving speed or driving direction of the host vehicle based on the location or speed of an external object obtained from the surrounding environment identification device 209. According to an embodiment, the autonomous driving system controller 211 may determine a deceleration of the host vehicle based on the location or speed of an external object obtained from the surrounding environment identification device 209. The autonomous driving system controller 211 may transmit setting values required for driving to the drive controller 213 based on information necessary for driving, such as the surrounding environment, legal conditions, and road conditions.

According to an embodiment, the drive controller 213 may operate the host vehicle based on a drive command received from the autonomous driving system controller 211.

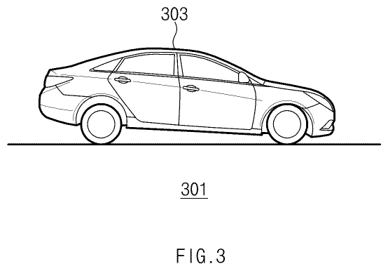

FIG. 3 shows an example of a host vehicle decelerating in a vehicle control device or vehicle control method according to an embodiment of the present disclosure.

Referring to FIG. 3, in situation 301, a host vehicle 303 may be decelerating. When the host vehicle 303 decelerates, torque may be applied to the steering wheel due to friction between the front wheel and the ground, which occurs according to the deceleration.

When the driver operates the steering wheel while torque is applied due to friction between the front wheel and the ground, a torque corresponding to the sum of torque due to the driver's operation and torque due to friction may be applied to the steering wheel. Therefore, an existing vehicle control device may incorrectly determine that the torque corresponding to the sum of the torque due to the driver's operation and the torque due to friction is instead the torque due to the driver's operation. Because the existing vehicle control device changes the driving direction of the host vehicle 303 based on the torque applied to the steering wheel, the existing vehicle control device may change the driving direction of the host vehicle to a greater extent than the degree of change in the driving direction according to the amount of the driver's operation. Accordingly, an accident risk related with driving according to the existing vehicle control device may be higher than an accident risk related with driving according to the vehicle control device according to an embodiment.

According to an embodiment, the processor of the vehicle control device included in the host vehicle 303 may determine whether condition that the steering wheel is operated with the amount of operation greater than the threshold value and for the time greater than the threshold time value is satisfied in order to determine whether the torque applied to the steering wheel is caused by operation according to the driver's intention, rather than by friction between the front wheel and the ground.

According to an embodiment, the threshold value and the threshold time value may be determined based on the maximum deceleration value among the decelerations of the host vehicle 303 measured during a specified time and a grip strength with which the steering wheel is gripped.

The processor of the vehicle control device may determine a default threshold value and a default threshold time value based on the maximum deceleration value. The processor of the vehicle control device may assign an operation weight and a time weight based on the grip strength with which the steering wheel is gripped. The processor of the vehicle control device may determine the threshold value based on a value obtained by multiplying the default threshold value by the operation weight. The processor of the vehicle control device may determine the threshold time value based on a value obtained by multiplying the default threshold time value by the time weight.

The relationship between the maximum deceleration value, the default threshold value, and the default threshold time value is described below with reference to FIG. 4.

The relationship between the grip strength with which the steering wheel is gripped, the operation weight, and the time weight is described below with reference to FIG. 5.

However, the torque applied to the steering wheel connected to the front wheel when the host vehicle accelerates may be smaller than the torque applied to the steering wheel when the host vehicle decelerates. Because the vehicle is biased in the opposite direction to the driving direction when the host vehicle accelerates, the friction applied to the front wheels when the host vehicle accelerates may be small compared to the friction applied to the front wheels when the host vehicle decelerates at a deceleration having a value equal to the value of the acceleration of the host vehicle. Therefore, the risk of an accident due to the torque applied to the steering wheel when the host vehicle decelerates may be greater than the risk of an accident due to the torque applied to the steering wheel when the host vehicle accelerates. Therefore, the processor of the vehicle control device may determine the threshold value and the threshold time value based on the deceleration rather than the acceleration of the host vehicle.

FIG. 4 shows an example of graphs showing the relationship between decelerations and thresholds in a vehicle control device or vehicle control method according to an embodiment of the present disclosure.

Referring to FIG. 4, a first graph 401 may represent accelerations of a host vehicle over time. The first graph 401 may determine a point 403 indicating the maximum deceleration value among the decelerations of the host vehicle measured during a specified time 405. A second graph 411 may represent a threshold value according to the maximum deceleration. A third graph 413 may represent a threshold time value according to the maximum deceleration. The deceleration may include a deceleration of the host vehicle in the longitudinal direction.

According to an embodiment, the processor of the vehicle control device may identify the maximum deceleration value among the decelerations of the host vehicle measured during the specified time 405 (e.g., about 4 seconds). In the first graph 401, the vertical axis represents a longitudinal acceleration, which is an acceleration in the longitudinal direction. Therefore, the point of the minimum longitudinal acceleration may represent the maximum deceleration value.

Point 403 may include a point representing the largest deceleration among deceleration values identified during the time between a certain point in time (e.g., t₂) and a point in time before a specified time (e.g., t₁). The specified time 405 may represent the time between the certain point in time (e.g., t₂) and the point in time before the specified time (e.g., t₁).

Because the torque applied to the steering wheel may vary due to the friction force of the front wheel according to the deceleration indicated by the point 403, the processor of the vehicle control device may switch control of driving of the host vehicle from the system for performing autonomous driving to the driver. The switch may occur to reduce an accident risk when the amount of the operation of the steering wheel that is equal to or greater than the threshold value is maintained for a threshold time value after the certain point in time (e.g., t₂).

In the second graph 411, the threshold value may be changed according to the maximum deceleration value. According to an embodiment, the processor of the vehicle control device may determine the default threshold value as a first value based on the maximum deceleration value being the first magnitude. The processor may also determine the threshold value as a second value greater than the first value based on the maximum deceleration value being the second magnitude greater than the first magnitude.

The processor of the vehicle control device may determine the threshold value based on the product of the default threshold value and an operation weight. Accordingly, when the operation weight is constant, the processor of the vehicle control device may determine, as the threshold value, a value greater than the threshold value determined corresponding to the maximum deceleration value that is the first magnitude, based on identifying that the maximum deceleration is the second magnitude.

In the third graph 413, the threshold time value may be changed according to the maximum deceleration value. According to an embodiment, the processor of the vehicle control device may determine the default threshold third value as a third value based on the maximum deceleration value being a third magnitude. The processor may also determine the threshold time value as a fourth value greater than the third value based on the maximum deceleration value being the fourth magnitude greater than the third magnitude.

The processor of the vehicle control device may determine the threshold time value based on the product of the default threshold time value and a time weight. Accordingly, when the time weight is constant, the processor of the vehicle control device may determine, as the threshold time value, a value greater than the threshold time value determined corresponding to the third magnitude less than the fourth magnitude, based on the maximum deceleration value being the fourth magnitude.

According to an embodiment, the processor of the vehicle control device may determine the threshold value based on a specified threshold value. The processor may determine the threshold time value based on a specified threshold time value in a failure situation in which the steering wheel is not operated by autonomous driving control. Because of a failure situation in which the steering wheel is not controlled according to autonomous driving, there is a need to switch control of driving from the system for performing autonomous driving to the driver.

FIG. 5 shows an example of a table showing the relationship between the gripping state of a steering wheel and weights in a vehicle control device or vehicle control method according to an embodiment of the present disclosure.

Referring to FIG. 5, a table 501 may represent operation weights and time weights according to a grip strength with which a steering wheel is gripped. The grip strength with which the steering wheel is gripped according to a first grip may be greater than the grip strength with which the steering wheel is gripped according to a second grip. A W1 value may be smaller than a W2 value. The W2 value may be smaller than a W3 value. The W1 value, W2 value, and W3 value may include values greater than 0 and less than or equal to 1. A W4 value may be smaller than a W5 value. The W5 value may be smaller than a W6 value. The W4 value, W5 value, and W6 value may include values greater than 0 and less than or equal to 1.

According to an embodiment, the processor of the vehicle control device may identify the grip strength with which the steering wheel is gripped through a touch sensor included in the steering wheel. The grip strength with which the steering wheel is gripped may be identified based on at least one of the contact area between the driver and the steering wheel, the distance between the driver and the steering wheel, or any combination thereof when the touch sensor includes a capacitive sensor. For example, when the driver grips the steering wheel with a grip strength greater than the reference strength, the contact area identified by the capacitive sensor may be wider than the contact area identified by the capacitive sensor when the driver grips the steering wheel with a grip strength less than or equal to the reference strength. For example, when the driver grips the steering wheel with a grip strength greater than the reference strength, the distance identified by the capacitive sensor may be shorter than the distance identified by the capacitive sensor when the driver grips the steering wheel with a grip strength less than or equal to the reference strength.

According to an embodiment, the processor of the vehicle control device may change the threshold value and the threshold time value based on the grip strength with which the steering wheel is gripped. This is because the greater the grip strength with which the steering wheel is gripped, the higher the probability that the operation of the steering wheel is in accordance with the user's intention.

According to an embodiment, the processor of the vehicle control device may assign a first operation weight (e.g., W2) based on the grip strength with which the steering wheel is gripped being the first strength (e.g., a second grip). The processor of the vehicle control device may determine the threshold value based on the product of the first operation weight (e.g., W2) and the default threshold value. The processor of the vehicle control device may assign a second operation weight (e.g., W1) less than the first operation weight based on the grip strength with which the steering wheel is gripped being the second strength (e.g., a first grip). The processor of the vehicle control device may determine the threshold value based on the product of the second operation weight (e.g., W1) and the default threshold value. The threshold value determined based on the first operation weight (e.g., W2) may be greater than the threshold value determined based on the second operation weight (e.g., W1).

According to an embodiment, the processor of the vehicle control device may determine the operation weight and the threshold value even when the steering wheel is in a non-grip state where the grip strength is zero.

The processor of the vehicle control device may assign a third operation weight (e.g., W3) based on that the driver does not grip the steering wheel (e.g., non-grip state). The processor of the vehicle control device may determine the threshold value based on the product of the third operation weight (e.g., W3) and the default threshold value. The processor of the vehicle control device may assign a fourth operation weight (e.g., W1 or W2) that is smaller than the third operation weight (e.g., W3) based on that the driver grips the steering wheel (e.g., first grip, or second grip). The processor of the vehicle control device may determine the threshold value based on the product of the fourth operation weight (e.g., W1, or W1) and the default threshold value. The threshold value determined based on the third operation weight (e.g., W3) may be greater than the threshold value determined based on the fourth operation weight (e.g., W1 or W2).

According to an embodiment, the processor of the vehicle control device may assign a first time weight (e.g., W4) based on the grip strength with which the steering wheel is gripped being the third strength (e.g., a first grip). The processor of the vehicle control device may determine the threshold time value based on the product of the first time weight and the default threshold time value. The processor of the vehicle control device may assign a second time weight (e.g., W5) greater than the first time weight (e.g., W4) based on the grip strength with which the steering wheel is gripped being the fourth strength (e.g., second grip) less than the third strength. The processor of the vehicle control device may determine the threshold time value based on the product of the first time weight (e.g., W4) and the default threshold time value. The threshold time value determined based on the first time weight (e.g., W4) may be greater than the threshold value determined based on the second time weight (e.g., W5).

According to an embodiment, the processor of the vehicle control device may determine the time weight and the threshold time value even when the steering wheel is in a non-grip state where the grip strength is zero.

The processor of the vehicle control device may assign a third time weight (e.g., W6) based on that the driver does not grip the steering wheel (e.g., non-grip state). The processor of the vehicle control device may determine the threshold time value based on the product of the third time weight (e.g., W6) and the default threshold time value. The processor of the vehicle control device may assign a fourth time weight (e.g., W4 or W5) that is smaller than the third time weight (e.g., W6) based on that the driver grips the steering wheel (e.g., first grip, or second grip). The processor of the vehicle control device may determine the threshold time value based on the product of the fourth time weight (e.g., W4 or W5) and the default threshold time value. The threshold time value determined based on the third time weight (e.g., W6) may be greater than the threshold time value determined based on the fourth time weight (e.g., W1 or W2).

Although the threshold time value is described as being changed depending on a deceleration in FIGS. 4 and 5, embodiments of the present disclosure may not be limited thereto.

According to an embodiment, the threshold value may be changed depending on the deceleration, and the threshold time value may be a constant value.

For example, when the maximum deceleration value among the decelerations of the host vehicle measured during a specified time is a fifth magnitude, the processor of the vehicle control device may determine a threshold value based on the product of a first default threshold value according to the deceleration value that is the fifth magnitude and an operation weight according to the grip strength with the steering wheel is gripped. The threshold time value may be determined as a constant value, regardless of the maximum deceleration value and the grip strength with which the steering wheel is gripped.

When the maximum deceleration value is a sixth magnitude greater than the fifth magnitude, the processor of the vehicle control device may determine the threshold value based on the product of the second default threshold value according to the deceleration value having the sixth magnitude, and based om an operation weight according to the grip strength with which the steering wheel is gripped. The threshold time value may be determined as a constant value, regardless of the maximum deceleration value and the grip strength with which the steering wheel is gripped.

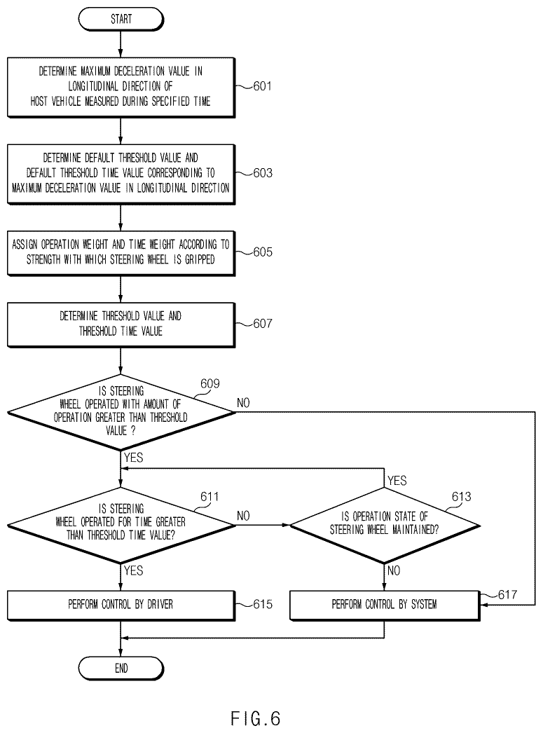

FIG. 6 shows a flowchart of an operation of a vehicle control device for switching control of driving to a driver based on a threshold value according to a deceleration and a threshold time value in a vehicle control device or a vehicle control method according to an embodiment of the present disclosure.

Hereinafter, it is assumed that the vehicle control device 101 of FIG. 1 performs the process of FIG. 6. Additionally, in the description of FIG. 6, operations described as being performed by the vehicle control device may be understood as being controlled by the processor 105 of the vehicle control device 101.

Referring to FIG. 6, in a first operation 601, the processor of the vehicle control device may determine a maximum deceleration value of the host vehicle in the longitudinal direction, which is measured during a specified time. The maximum deceleration value of the host vehicle in the longitudinal direction may include the maximum deceleration value among the decelerations of the host vehicle in the longitudinal direction, which are measured during the specified time.

In a second operation 603, the processor of the vehicle control device may determine a default threshold value and a default threshold time value corresponding to the maximum deceleration value in the longitudinal direction. As the maximum deceleration value in the longitudinal direction increases, the default threshold value and the default threshold time value may increase.

In a third operation 605, the processor of the vehicle control device may assign an operation weight and a time weight according to the grip strength with which the steering wheel is gripped. The greater the grip strength with which the steering wheel is gripped, the lower the operation weight and the time weight.

In a fourth operation 607, the processor of the vehicle control device may determine the threshold value and the threshold time value. The threshold value may be determined based on the product of a default threshold value and an operation weight. The threshold time value may be determined based on the product of a default threshold time value and a time weight.

In a fifth operation 609, the processor of the vehicle control device may identify whether the steering wheel is operated with an amount of operation that is greater than the threshold value. When the steering wheel is operated with the amount of operation which is greater than the threshold value (YES in S609), the processor of the vehicle control device may perform a sixth operation 611. When the steering wheel is not operated with the amount of operation that is greater than the threshold value (NO in S609), the processor of the vehicle control device may perform a seventh operation 617.

According to an embodiment, the processor of the vehicle control device may identify the amount of operation of the steering wheel through a torque sensor included in the steering wheel, but embodiments of the present disclosure may not be limited thereto. The amount of operation of the steering wheel may be identified based on a torque or a force applied to the steering wheel.

According to an embodiment, the processor of the vehicle control device may perform the fifth operation 609 and the sixth operation 611 to determine whether an accident risk is less than a reference value. A situation where whether the accident risk is greater than or equal to the reference value may include situations where the operation of the steering wheel is not due to the user's intention, or situations where there is a risk of overturn or collision due to a sudden change in direction.

In the sixth operation 611, the processor of the vehicle control device may determine whether the steering wheel is operated for a time greater than the threshold time value. When the steering wheel is operated for the time greater than the threshold time value (YES in S611), the processor of the vehicle control device may perform an eighth operation 615. When the steering wheel is not operated for the time greater than the threshold time value (NO ins S611), the processor of the vehicle control device may perform a ninth operation 613.

In the eighth operation 615, the processor of the vehicle control device may perform control by the driver. In other words, the processor of the vehicle control device may switch control of driving of the host vehicle to the driver

In the ninth operation 613, the processor of the vehicle control device may determine whether the operation state of the steering wheel is maintained. When the operation state of the steering wheel is maintained (YES in S613), the processor of the vehicle control device may perform the sixth operation 611. When the operation state of the steering wheel is not maintained (NO in S613), the processor of the vehicle control device may perform the seventh operation 617.

According to an embodiment, the reason for this is that a condition that the steering wheel is operated for a time that is greater than the threshold time value may be satisfied as the time has elapsed when the steering wheel is maintained in the operation state.

In the seventh operation 617, the processor of the vehicle control device may perform control by the autonomous driving system. In other words, the processor of the vehicle control device may maintain control of the operation of the host vehicle given to the system for performing autonomous driving or the driver assistance system and may not switch control of driving of the host vehicle to the driver.

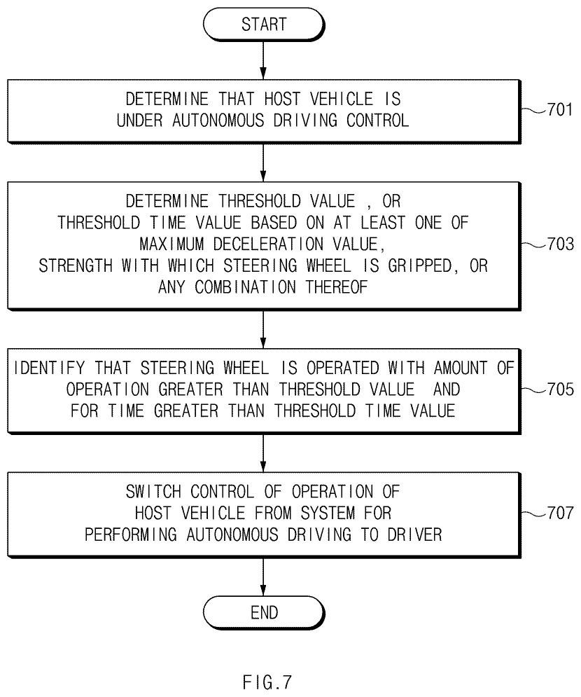

FIG. 7 shows a flowchart of operation of a vehicle control device for switching control of driving to a driver in a vehicle control device or a vehicle control method according to an embodiment of the present disclosure.

Hereinafter, it is assumed that the vehicle control device 101 of FIG. 1 performs the process of FIG. 7. Additionally, in the description of FIG. 7, operations described as being performed by the vehicle control device may be understood as being controlled by the processor 105 of the vehicle control device 101.

Referring to FIG. 7, in a first operation 701, the processor of the vehicle control device may determine that the host vehicle is under autonomous driving control.

In a second operation 703, the processor of the vehicle control device may determine a threshold value, or a threshold time value based on at least one of the maximum deceleration value, the grip strength with which the steering wheel is gripped, or any combination thereof. The maximum deceleration value may include the maximum deceleration value among the decelerations of the host vehicle measured during a specified time.

In a third operation 705, the processor of the vehicle control device may identify that the steering wheel is operated with an amount of operation that is greater than the threshold value and for a time that is greater than the threshold time value.

In a fourth operation 707, the processor of the vehicle control device may switch the subject who has control of the operation of the host vehicle, i.e., switch driving control or control of driving, from the system for performing autonomous driving to the driver. The processor of the vehicle control device may switch control of driving of the host vehicle to the driver based on identifying that the steering wheel is operated with an amount of operation that is greater than the threshold value and for a time that is greater than the threshold time value although the host vehicle is under autonomous driving control.

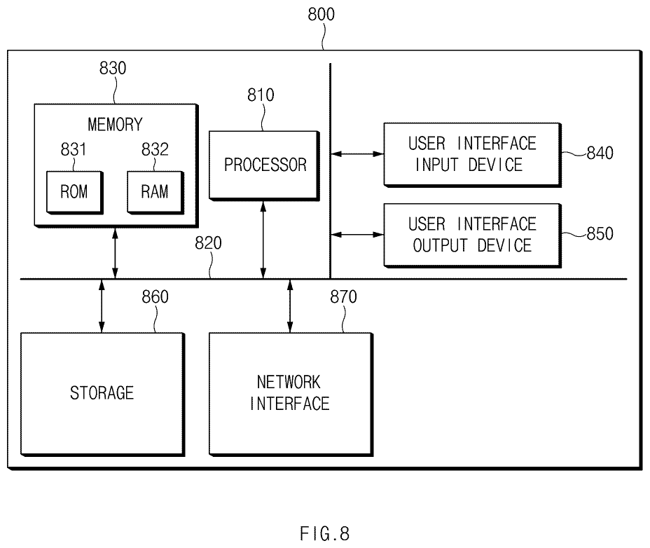

FIG. 8 shows a computing system related to a vehicle control device or vehicle control method according to an embodiment of the present disclosure.

Referring to FIG. 8, a computing system 800 may include at least one processor 810, a memory 830, a user interface input device 840, a user interface output device 850, a storage 860, and a network interface 870, which are connected with each other via a bus 820.

The processor 810 may be a central processing unit (CPU) or a semiconductor device that processes or executes instructions stored in the memory 830 and/or the storage 860. The memory 830 and the storage 860 may include various types of volatile or non-volatile storage media. For example, the memory 830 may include a Read Only Memory (ROM) 831 and a Random Access Memory (RAM) 832.

Thus, the operations of the method or the algorithm described in connection with the embodiments disclosed herein may be embodied directly in hardware or a software module executed by the processor 810, or in a combination thereof. The software module may reside on a storage medium (i.e., the memory 830 and/or the storage 860) such as a RAM, a flash memory, a ROM, an EPROM, an EEPROM, a register, a hard disk, a removable disk, and a CD-ROM.

The disclosed storage medium may be coupled to the processor 810 and the processor 810 may read information out of the storage medium and may record information in the storage medium. Alternatively, the storage medium may be integrated with the processor 810. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure. Various modifications and variations may be made without departing from the essential characteristics of the present disclosure by those of ordinary skill in the art to which the present disclosure pertains.

Accordingly, the embodiments described and shown in the present disclosure are not intended to limit the technical idea of the present disclosure but to describe the technical idea of the present disclosure. The scope of the technical idea of the present disclosure is not limited by the disclosed embodiments. The scope of protection of the present disclosure should be interpreted by the following claims. All technical ideas within the scope of the claims and equivalents thereto should be construed as being included in the scope of the present disclosure.

The present technology may determine whether the operation of a steering wheel is caused by a driver's intention based on the amount of operation of the steering wheel of a host vehicle and a time for which the operation of the steering wheel is maintained under autonomous driving control.

The present technology may determine whether the operation of the steering wheel is caused by a driver's intention based on the driver's gaze under autonomous driving control.

Further, the present technology may reduce an accident risk due to operation of a steering wheel under autonomous driving control.

In addition, various effects may be provided that are directly or indirectly understood through the present disclosure.

Hereinabove, although the technical concepts of the present disclosure have been described with reference to various embodiments and the accompanying drawings, the present disclosure is not limited thereto. The embodiments may be variously modified and altered by those of ordinary skill in the art to which the present disclosure pertains without departing from the spirit and scope of the present disclosure claimed in the following claims.

What is claimed is:

1. A vehicle control device comprising:
a steering wheel configured to specify a driving direction of a host vehicle; and
a processor,
wherein the processor is configured to
determine that the host vehicle is under autonomous driving control,
determine a threshold value or a threshold time value based on at least one of a maximum deceleration value among decelerations of the host vehicle measured during a specified time, a grip strength with which the steering wheel is gripped, or any combination thereof; and
switch control of driving of the host vehicle from a system for performing the autonomous driving to a driver based on the steering wheel being operated with an amount of operation greater than the threshold value or for a time greater than the threshold time value.

2. The vehicle control device of claim 1, wherein, in a failure situation in which the steering wheel is not operated by the autonomous driving control, the processor is configured to:
determine the threshold value based on a specified threshold value; and
determine the threshold time value based on a specified threshold time value.

3. The vehicle control device of claim 1, wherein the processor is configured to:
determine the threshold value to be a first value based on the maximum deceleration value being a first magnitude; and
determine the threshold value to be a second value greater than the first value based on the maximum deceleration value being a second magnitude greater than the first magnitude.

4. The vehicle control device of claim 1, wherein the processor is configured to:
determine the threshold time value to be a third value based on the maximum deceleration value being a third magnitude; and
determine the threshold time value to be a fourth value greater than the third value based on the maximum deceleration value being a fourth magnitude greater than the third magnitude.

5. The vehicle control device of claim 1, wherein the processor is configured to:
assign a first weight value as an operation weight based on the grip strength being a first strength; and
assign a second weight value less than the first weight value as the operation weight based on the grip strength being a second strength greater than the first strength,
wherein a threshold time value determined based on the first weight value is configured to be greater than a threshold time value determined based on the second weight value.

6. The vehicle control device of claim 1, wherein the processor is configured to:
assign a third weight value as a time weight based on the grip strength being a third strength; and
assign a fourth weight value less than the third weight value as the time weight based on the grip strength being a fourth strength greater than the third strength,
wherein a threshold time value determined based on the third weight value is configured to be greater than a threshold time value determined based on the fourth weight value.

7. The vehicle control device of claim 1, wherein the processor is configured to:
assign a fifth weight value as an operation weight, based on the driver not gripping the steering wheel; and
assign a sixth weight value less than the fifth weight value as the operation weight based on the driver gripping the steering wheel,
wherein a threshold value determined based on the fifth weight value is configured to be greater than a threshold value determined based on the sixth weight value.

8. The vehicle control device of claim 1, wherein the processor is configured to:
assign a seventh weight value as a time weight, based on the driver not gripping the steering wheel; and
assign an eighth weight value less than the seventh weight value as the time weight based on the driver gripping the steering wheel,
wherein a threshold time value determined based on the seventh weight value is configured to be greater than a threshold time value determined based on the eighth weight value.

9. The vehicle control device of claim 1, wherein the processor is configured to identify the grip strength based on at least one of a contact area between the driver and the steering wheel, a distance between the driver and the steering wheel, or any combination thereof.

10. The vehicle control device of claim 1, wherein the processor is configured to:
identify the grip strength through a touch sensor included in the steering wheel; or
identify the amount of operation of the steering wheel through a torque sensor included in the steering wheel.

11. A vehicle control method comprising:
determining that a host vehicle is under autonomous driving control;
determining a threshold value or a threshold time value based on at least one of a maximum deceleration value among decelerations of the host vehicle measured during a specified time, a grip strength with which a steering wheel is gripped, or any combination thereof; and
switching control of driving of the host vehicle from a system for performing the autonomous driving to a driver based on the steering wheel being operated with an amount of operation greater than the threshold value or for a time greater than the threshold time value.

12. The vehicle control method of claim 11, in a failure situation in which the steering wheel is not operated by the autonomous driving control, the method further comprising:
determining the threshold value based on a specified threshold value; and
determining the threshold time value based on a specified threshold time value.

13. The vehicle control method of claim 11, wherein determining the threshold value or the threshold time value includes:
determining the threshold value to be a first value based on the maximum deceleration value being a first magnitude; and
identifying the threshold value to be a second value greater than the first value based on the maximum deceleration value being a second magnitude greater than the first magnitude.

14. The vehicle control method of claim 11, wherein determining the threshold value or the threshold time value includes:
determining the threshold time value to be a third value based on the maximum deceleration value being a third magnitude; and
determining the threshold time value to be a fourth value greater than the third value based on the maximum deceleration value being a fourth magnitude greater than the third magnitude.

15. The vehicle control method of claim 11, wherein determining the threshold value or the threshold time value includes:
assigning a first weight value as an operation weight based on the grip strength being a first strength; and
assigning a second weight value less than the first weight value as the operation weight based on the grip strength being a second strength greater than the first strength,
wherein a threshold time value identified based on the first weight value is greater than a threshold time value identified based on the second weight value.

16. The vehicle control method of claim 11, wherein determining the threshold value or the threshold time value includes:
assigning a third weight value as a time weight based on the grip strength being a third strength; and
assigning a fourth weight value less than the third weight value as the time weight based on the grip strength being a fourth strength greater than the third strength,
wherein a threshold time value determined based on the third weight value is greater than a threshold time value determined based on the fourth weight value.

17. The vehicle control method of claim 11, wherein determining the threshold value or the threshold time value includes
assigning a fifth weight value as an operation weight, based on the driver not gripping the steering wheel; and
assigning a sixth weight value less than the fifth weight value as the operation weight based on the driver gripping the steering wheel,
wherein a threshold value determined based on the fifth weight value is greater than a threshold value determined based on the sixth weight value.

18. The vehicle control method of claim 11, wherein determining the threshold value or the threshold time value includes
assigning a seventh weight value as a time weight, based on the driver not gripping the steering wheel; and
assigning an eighth weight value less than the seventh weight value as the time weight based on the driver gripping the steering wheel,
wherein a threshold time value determined based on the seventh weight value is greater than a threshold time value determined based on the eighth weight value.

19. The vehicle control method of claim 11, wherein determining the threshold value or the threshold time value includes identifying the grip strength based on at least one of a contact area between the driver and the steering wheel, a distance between the driver and the steering wheel, or any combination thereof.

20. The vehicle control method of claim 11, wherein:
determining the threshold value or the threshold time value includes identifying the grip strength through a touch sensor included in the steering wheel, and
switching control of driving of the host vehicle includes identifying the amount of operation of the steering wheel through a torque sensor included in the steering wheel.
